(19) United States
(12) Patent Application Publication
(10) Pub. No.: US 2012/0118795 A1
(43) Pub. Date: May 17, 2012

(54) Gold refining apparatus

(76) Inventor: Mark Ellery Ogram, Tucson, AZ (US)

(21) Appl. No.: 12/927,527

(22) Filed: Nov. 17, 2010

(51) Int. Cl. B07B 9/02; B07B 4/00

(52) U.S. Cl. 209/34; 209/136

(57) ABSTRACT

A refining mechanism for separating particles based upon their density. The mixed particles are deposited near an upper edge of an air suspension vibrating table and permitted to drift to a lower edge. A trough is positioned at the lower edge; the lower edge of the air suspension vibrating table is selectively deformed allowing the denser particles to pass under the trough while the lighter particles are collected by the trough. Ideally, a control mechanism is used to control the entire operation including the amount of deformation, the amount of air pressure being delivered to the table and the amount of vibration.

### BACKGROUND OF THE INVENTION

This invention relates to refining and more particularly to refining of denser materials from lighter ones.

Although the following discussion relates to the refining of gold, the invention is not intended to be so limited. Those of ordinary skill in the art readily recognize that the invention applies to any situation where a mixture is to be separated based upon the density of the particles.

Gold is, and will continue to be, a universal currency. Investors buy gold as a curb in unstable times and gold provides the industrial world with benefits that cannot be met by other metals; but, obtaining gold from ore deposits is a particularly difficult process since often the concentration of gold is too small to economically justify the gold's extraction.

Refining of gold is done through a variety of techniques. One is known as the Wohlwill process utilizing an electrochemical process where a gold dore bar serves as an anode. The anode is dissolved and deposited on the cathode which is eventually removed to yield up to 99.95% purity.

While the Wohlwill process is effective it requires expensive equipment and operations and produces toxic by-products. Even further, the Wohlwill process is only useful where the gold is already in highly concentrated form and does nothing to assist in the harvesting of the gold from the field where the concentration of gold is minimal.

The Miller process also produces highly pure gold but it too uses toxic materials. In the Miller process, a steam of pure chlorine gas is blown through the molten gold. The impurities in the sample form chlorides which are then removed.

As with Wohlwill, Miller does not assist in refining the gold in the field and it produces a large amount of toxic materials.

A less dramatic process is Cupellation which treats the sample under high temperatures to separate the noble metals. While this process has been used since the early bronze age, Cupellation has been found to be ineffective when the gold is in low concentrations.

Another approach to the task is described in U.S. Pat. No. 6,500,231, entitled “Recovery of Precious Metals from Thiosulfate Solutions” issued to Wan on Dec. 31, 2002, and incorporated hereinto by reference. The Wan approach creates a leaching process using a thiosulfate lixiviant for the precious metals. Wan, as with the other techniques, produces a large level of toxic materials that must be discarded and is expensive to operate.

It is clear there is a need for an improved refining method.

### SUMMARY OF THE INVENTION

The invention provides a refining mechanism for separating particles based upon their density. The following discussion relates to the separation of gold concentrates from a source with extremely low concentrations of gold; but, the invention is not intended to be so limited and includes the separation of particles based upon their density.

In a typical field where the concentration of gold within the source is low, the source material is separated by size using a screen or a series of screens. Once the source has been so classified, a chosen classification is placed onto a vibrating table which is equipped with an air suspension. In this context, an example of a vibrating table is described in U.S. Pat. No. 4,946,586, entitled “Gravitation Separation” issued to Fletcher on Aug. 7, 1990; and U.S. Pat. No. 5,160,035, entitled “Particle Concentrator and Method of Operation” issued to McConnell on Nov. 3, 1992; both of which are incorporated hereinto by reference.

Commercially available shaking tables are also available from a variety of sources including, but not limited to: Jiangxi Gandong Mining Equipment Manufacturer; Madden Steel Inc.; and COPG Mineral Technologies.

These shaking tables are modified through the addition of a multiplicity of holes through the table which allow pressurized air to flow therethrough to create an “air bed”; the resulting mechanism is an air suspension vibrating table. The air suspension vibrating table is placed at a slope.

The classified ore mixture is deposited near an upper edge of an air suspension vibrating table and permitted to drift by gravity on the air bed to a lower edge.

A trough is positioned at the lower edge. This trough is used to convey one group (such as the unwanted debris) away for disposal.

To collect the sought after gold, the lower edge of the air suspension vibrating table is selectively deformed so that, in the deformed area, the edge of the table is below the trough. This creates a “valley” and allows the denser particles to pass under the trough while the lighter particles are collected by the trough. The denser particles form a highly concentrated ore flow.

By using a series of air suspension vibrating tables in this manner, each air bed being fed the concentrate from the previous air bed, the ore continues to be concentrated until at the final stage, a highly concentrated flow of gold is created.

Ideally, a control mechanism is used to control the entire operation including the amount of deformation, the amount of air pressure being delivered to the table, the amount of vibration, and the declination angle of the air suspension vibrating table surface.

In this manner, the gold in refined into a concentrated group ready for smelting without using any chemicals whatsoever.

More particularly, to form this system, the table has an upper edge and an opposing lower edge. The table has a multiplicity of holes therethrough. The size of the holes is chosen to meet the weight requirements for the ore being processed.

A vibrator is secured to the table causing said table to vibrate. This vibrator is well known to those of ordinary skill in the art and includes such mechanisms as cams, bumpers, and the like.

Utilizing an air source, a flow of air is pressed through the holes in the table. This provides an airbed on which the ore is suspended as it “flows” down the inclined table.

A trough is positioned along the lower edge of said table to collect the debris from the table. In some embodiments, the trough is equipped with an auger to assist in moving the debris away for later disposal. A leading edge of the trough is ideally positioned aligned with the upper surface of the air suspension vibrating table on which the ore moves.

A portion of the bottom edge of the table is deformed below the trough, thereby forming a valley into which the heavier ore naturally drifts during the ore's travel down the table. This deformation is created by a deforming mechanism which either pulls or pushes the edge of the table away from the trough's leading edge.

The ore source, which has been classified, is deposited at the top of the table and allowed to drift downward to be concentrated as outlined above to generate a concentrated ore flow.

In some embodiments, this ore flow is further concentrated by subsequent air suspension vibrating tables as outline above, which continues the refining until the desired purity is obtained.

In even further embodiments, depending on the original ore source, heavy particles which might be retained among the gold even after concentration (such as ferrous particles), can be separated by an electro-magnet directed toward the falling concentrate the electro-magnet pulls the ferrous materials while not affecting the gold particles.

A controller mechanism allows the operator to adjust the various parameters so that the concentrated gold has the concentration sought based upon the ore source. Ideally the adjustments available are to:
1) the amount of deformation applied to the edge of the table (allowing for accurate separation based upon ore concentration);
2) the air pressure (permitting the mechanism to handle varying densities of ore);
3) the amount of vibration (permitting variation in the agitation of the ore during the settling process);
4) the incline of the table (permitting adjustment to the “dwell” time of the ore on the table); and,
5) in some embodiments, the magnetic power of the electro magnet affecting the concentrated ore flow.

The invention, and its various embodiments, will be more fully explained by the accompanying drawings and the following descriptions thereof.

### DRAWINGS IN BRIEF

FIG. 1 is an operational layout of the preferred embodiment of the invention.

FIGS. 2A, 2B, and 2C illustrate various embodiments of mechanisms used to deform the air suspension shaking table.

FIG. 3 illustrates an embodiment of the invention utilizing multiple air suspension shaking tables for enhanced refinement of the ore.

FIG. 4 is a top view of the embodiment illustrated in FIG. 3.

FIG. 5 illustrates the use of an electromagnet to assist in further refining of the ore generated after the air suspension shaking tables.

FIG. 6 is a flowchart of an operation of the controlling computer of this invention.

FIGS. 7A and 7B illustrate the preferred trough and deformation mechanism interaction.

### DRAWINGS IN DETAIL

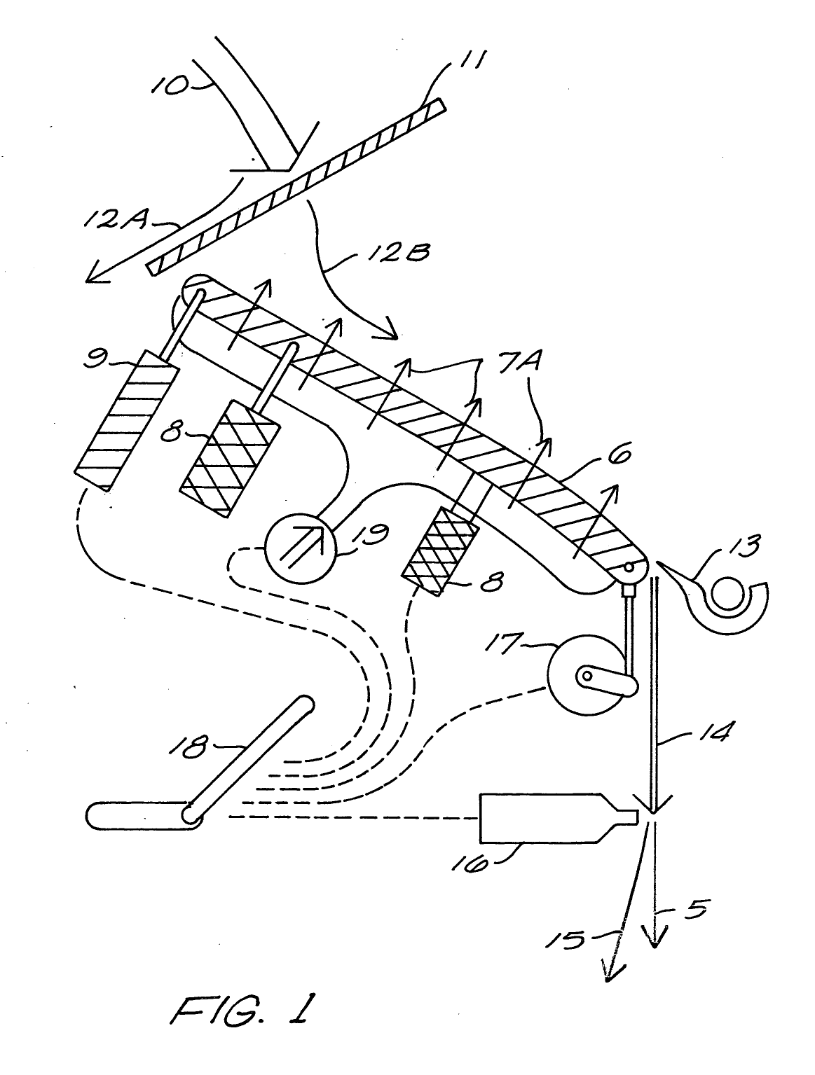

FIG. 1 is an operational layout of the preferred embodiment of the invention.

Source 10 of the ore is deposited onto screen 11. Screen 11 classifies the ore permitting the proper size/classified ore 12B to pass therethrough to the air suspension vibrating table 6. Ore which is not of the desired size is diverted as indicated by arrow 12A.

Air suspension vibrating table 6 is tilted by ram 9 so that the classified ore 12B is deposited onto the top of air suspension vibrating table 6. Air pump 19 directs a flow of air through holes in the air suspension vibrating table 6 as indicated by arrows 7A. This air flow suspends the classified ore 12 as it drifts down air suspension vibrating table 6.

Shaker 8 provides a vibrating motion to the table 6.

Trough/auger 13 is positioned at the bottom edge of table 6. Deformer 17 pulls a portion of the table 6's edge below the lip of trough/auger 13. This deformation of the lower edge forms a valley up table 6 allowing the heavier ore to collect in the valley during the classified ore 12B movement down table 6.

Since the deformed lower edge of table 6 is below a collection tray of trough/auger 13, the ore escaping under the trough/auger 13 is concentrated ore which falls to a collection bin (not shown). As the ore falls, in this embodiment, electro-magnet 16 creates a magnetic field to pull some debris 15 away from the gold 5.

In the preferred embodiment, operation of the entire system is done via a controller 18, a computer in this illustration. Using a controller allows the operator to adjust ram 9 (adjusting the tilt of table 6), air pump 19 (adjusting the floatation of the ore on table 6), the shaker 8 (the amount of agitation being delivered), deformer 17 (adjusting the depth of the valley in which the gold flows), and the electro-magnet 16 (controlling the final purification of the gold). With this level of control, the operator is able to finely tune the mechanism to fit the ore from source 10 to obtain optimal results.

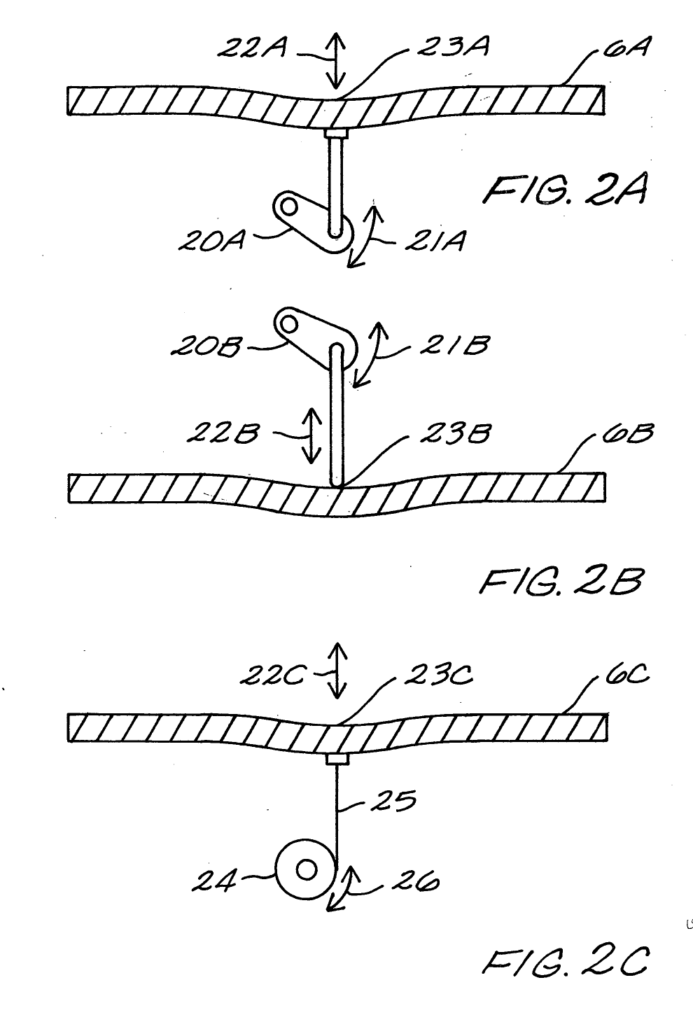

FIGS. 2A, 2B, and 2C illustrate various embodiments of mechanisms used to deform the air suspension shaking table.

Referring to FIG. 2A, in this embodiment table 6A has cam 20A positioned below with a connecting rod secured to the bottom of table 6A. As cam 20A is rotated 21A by a stepper motor (not shown), motion 22A is created forming gold channel 23A.

In FIG. 2B, cam 20B with its associated connecting rod is positioned above table 6B. A stepper motor (not shown) rotates cam 20B to press table 6B downward as shown by arrows 22B to form gold channel 23B.

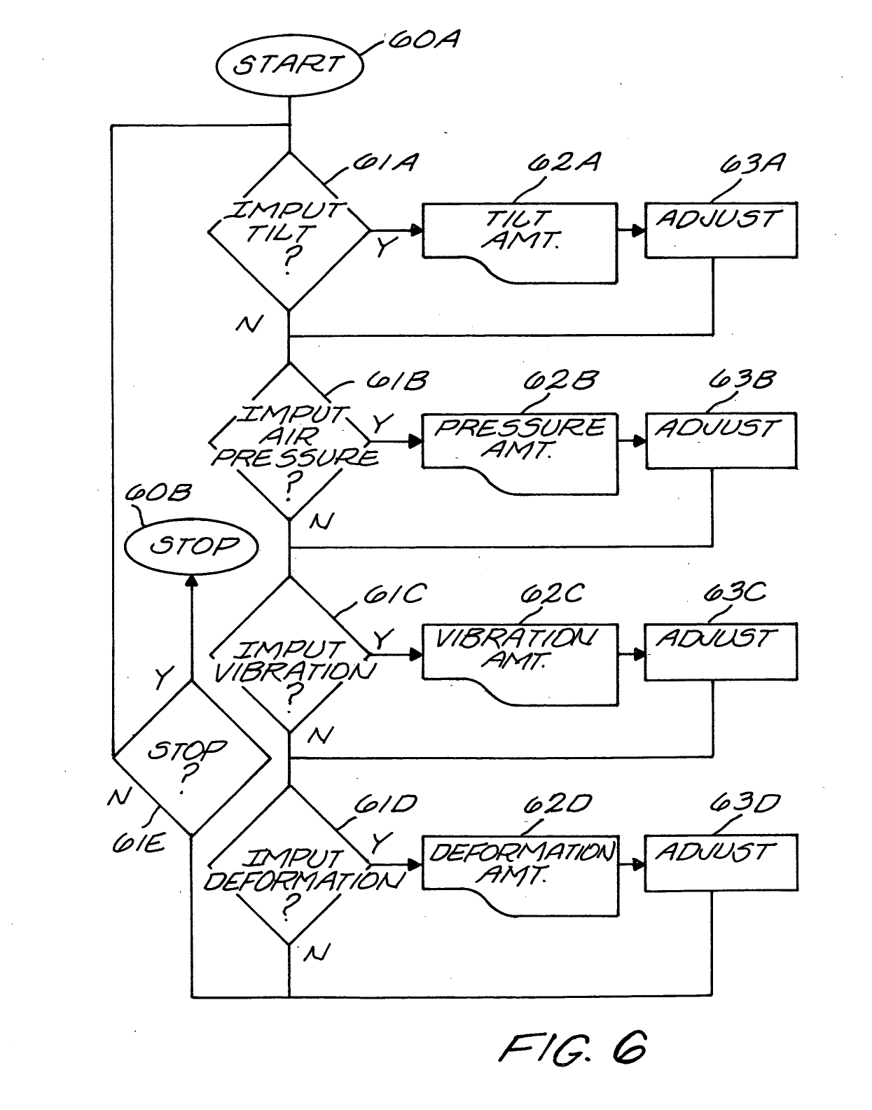

Another mechanism for deforming the table is shown in FIG. 6C. In this embodiment, reel 24 has cable 25 attached thereto and to the bottom of table 6C. A stepper motor (not shown) causes reel to move as indicated by arrows 26 causing motion 22C thereby creating gold channel 23C.

In this manner, the gold channels form a valley into which the heavier gold settles during the ore's motion down the table.

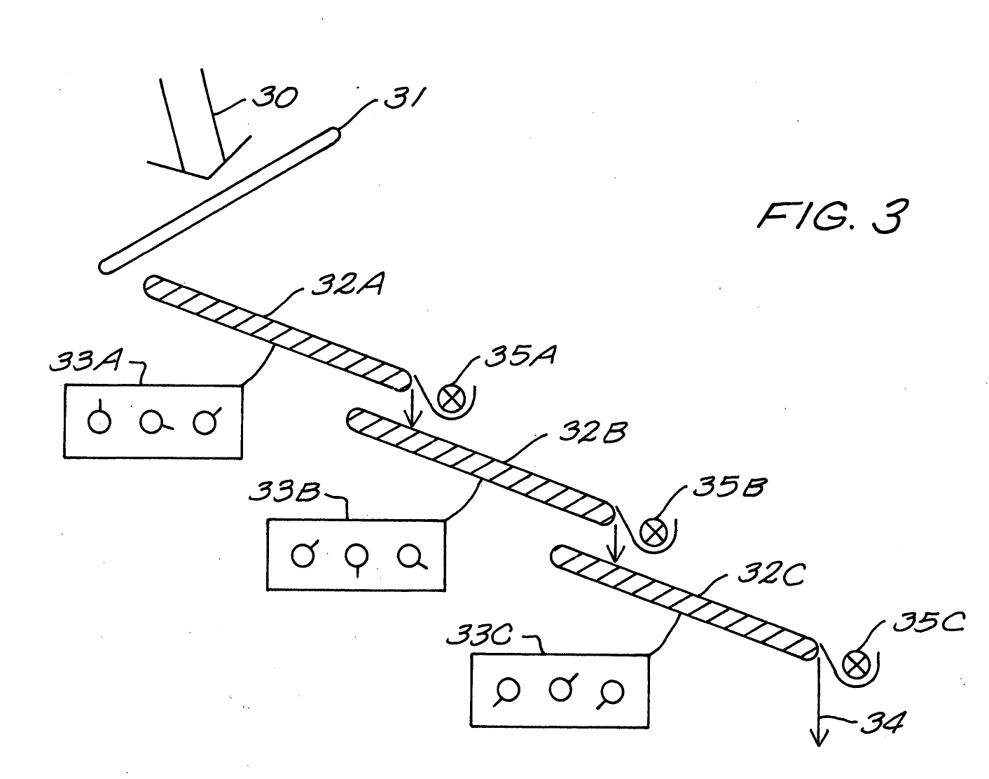

FIG. 3 illustrates an embodiment of the invention utilizing multiple air suspension shaking tables for enhanced refinement of the ore.

As shown, the ore source 30 passes through screen 31 where the ore is classified according to size permitting only the chosen diameter to enter the system. The classified ore is processed by air suspension shaking table 32A as described above. The debris from air suspension shaking table 32A is removed by trough/auger 35A and the refined ore is deposited onto air suspension shaking table 32B.

Control 33A (manual in this illustration) permits the operator to adjust the parameters of air suspension shaking table 32A to obtain the desired results.

The preliminary refined ore from air suspension shaking table 32A falls onto air suspension shaking table 32B. The debris from air suspension shaking table 32B is removed by trough/auger 35B and the refined ore is deposited onto air suspension shaking table 32C. In this way, the ore in further refined.

Manual controls 33B permit the operator to adjust the parameters of air suspension shaking table 32B to obtain the desired results.

The enhanced refined ore from air suspension shaking table 32B falls onto air suspension shaking table 32C for the final refinement of this illustration. The debris from air suspension shaking table 32C is removed by trough/auger 35C and the now fully refined gold 34 is deposited into a collection bin.

Manual controls 33C permit the operator to adjust the parameters of air suspension shaking table 32C to obtain the desired results.

While this illustration shows three air suspension shaking tables, the invention is not so limited as any number of air suspension shaking tables may be employed to obtain the desired refinement of the ore.

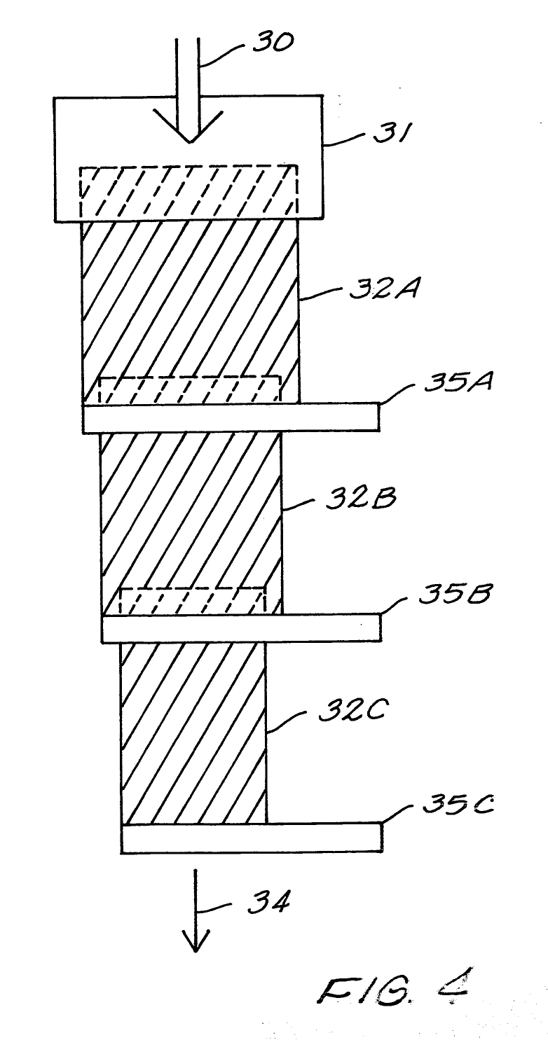

FIG. 4 is a top view of the embodiment illustrated in FIG. 3.

As described above, ore source 30 passes through screen/classifier 31 where the ore is classified according to size, permitting only the chosen diameter to enter the system. The classified ore is processed by air suspension shaking table 32A as described above. The debris from air suspension shaking table 32A is removed by trough/auger 35A and the preliminarily refined ore is deposited onto air suspension shaking table 32B.

The preliminarily refined ore from air suspension shaking table 32A falls onto air suspension shaking table 32B. The debris from air suspension shaking table 32B is removed by trough/auger 35B and the refined ore is deposited onto air suspension shaking table 32C. In this way, the ore in further refined.

The enhanced refined ore from air suspension shaking table 32B falls onto air suspension shaking table 32C for the final refinement of this illustration. The debris from air suspension shaking table 32C is removed by trough/auger 35C and the now fully refined gold 34 is deposited into a collection bin.

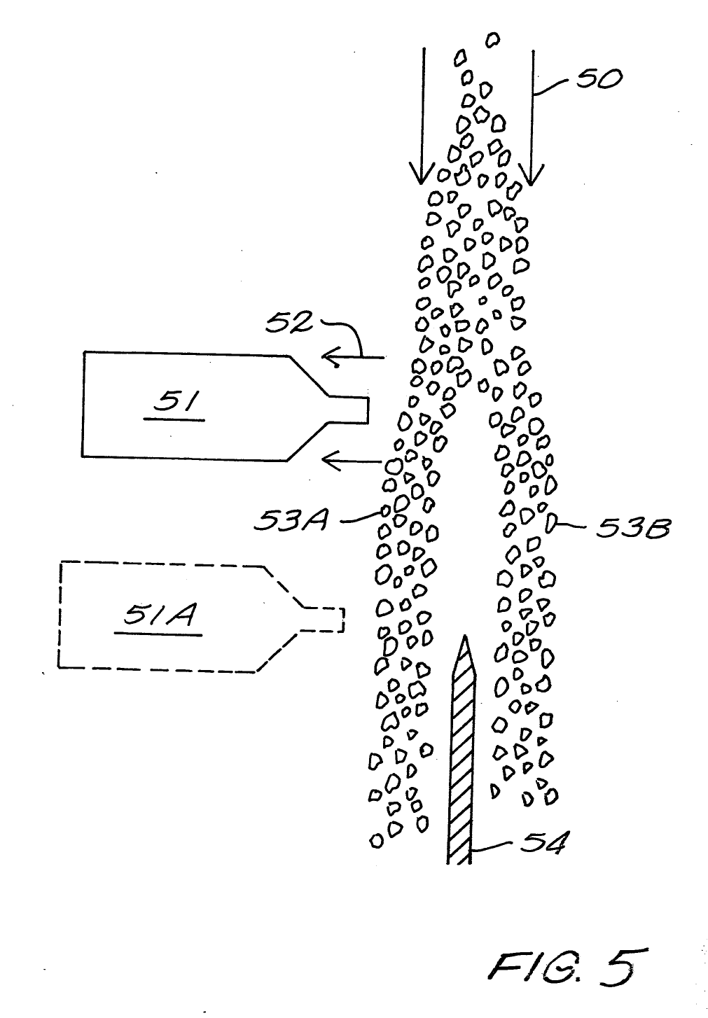

FIG. 5 illustrates the use of an electromagnet to assist in further refining of the ore generated after the air suspension shaking tables.

The refined and classified ore 50 contains both gold and non-gold. Some of this non-gold has magnetic properties so that as ore 50 falls, the ore is subjected to magnetic field 52 created by electro-magnet 51. Magnetic field 52 pulls the ore particles which have magnetic properties away from the normal path 53A while allowing the gold (which does not have magnetic properties) 53B to fall directly. Divider 54 directs the two streams 53A and 53B to their respective collection bins.

In some embodiments of the invention, multiple magnets 51A are used to further deflect the ferrous materials from the gold.

FIG. 6 is a flowchart of an operation of the controlling computer of this invention.

Once the program starts 60A, the program determines if the operator has entered a command to change the tilt 61A. if so, the new tilt value is determined 62A, and the tilt mechanism for the air suspension vibrating table is adjusted appropriately 63A.

The program then determines if an input of the air pressure has been made 61B. If there has been an adjustment of the air pressure, then the new pressure amount is received 62B and the air pressure is properly adjusted 63B.

Input of the vibration level 61C is monitored and if a change occurs, the new vibration amount 62C is gathered and the vibrating mechanism is adjusted 63C.

In similar fashion, changes in the operator's choice for the deformation of the air suspension vibrating table is monitored 61D. If there is a change, the new deformation is determined 62D and the deformation mechanism is adjusted appropriately 63D.

The program then determines if the operator has indicated a stop to the process 61E and if so, the program stops 60B; otherwise, the program loops back to monitor for the inputs of tile 61A.

In this manner, the entire operation is adjustable by the operator via the computer.

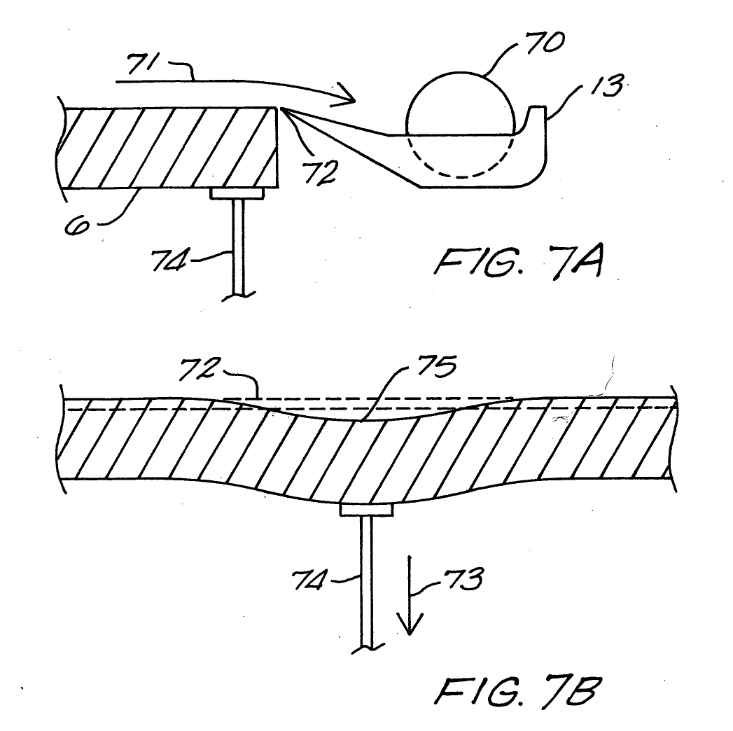

FIGS. 7A and 7B illustrate the preferred trough and deformation mechanism interaction.

Table 6, as described above, moves and separates ore 71 using vibration and air suspension. Trough 13 has a leading lip 72 which is aligned with an upper edge of table 6. Auger 70 is used to remove the debris from the site.

Deformation mechanism 74, in this embodiment, pulls a portion of table 6 downward below leading lip 72 of trough 13 to form valley 75. Valley 75 naturally collects the heavier gold which escapes capture by trough 13.

It is clear that the present invention provides for a highly improved refining mechanism which is ideally suited for the separation of gold.

What is claimed is:

1. A refining mechanism comprising:
a) a table having an upper edge and an opposing lower edge, said table having a multiplicity of holes therethrough;
b) a vibrator mechanism secured to said table causing said table to vibrate;
c) an air source providing pressurized air through said multiplicity of holes in the table;
d) a trough positioned along the lower edge of said table, said trough configured to transport debris from the table;
e) a deforming mechanism positioned to deform the lower edge of said table such that a portion of an upper surface of the table is positioned below said trough;
f) a source of dry particles positioned to deposit said particles onto said table proximate to the upper edge; and,
g) a controller adjusting said deforming mechanism in response to a first operator input.

2. The refining mechanism according to claim 1, wherein said controller further adjusts said air source in response to a second operator input.

3. The refining mechanism according to claim 1, further including a catch basin for material from the deformed lower edge of said table and not being collected by said trough.

4. The refining mechanism according to claim 3, wherein said deforming mechanism includes:
a) a motor; and,
b) a cam mechanism secured to said table proximate to the lower edge of said table such that movement of said cam deforms said table proximate to the position of said cam mechanism.

5. The refining mechanism according to claim 4, wherein said cam mechanism is secured to a bottom surface of said table.

6. The refining mechanism according to claim 5, wherein said cam mechanism includes a pulling rod connecting said cam mechanism to said bottom surface of said table proximate to the lower edge.

7. The refining mechanism according to claim 4 wherein said cam mechanism presses on the top of said table.

8. The refining mechanism according to claim 3, further including a classification mechanism interposed between said source of particles and said table, said classification mechanism permitting only a defined diameter of particles to pass therethrough to the table.

9. A refining mechanism receiving particles, said refining mechanism comprising:
a) a vibrating table having an upper edge and an opposing lower edge, said vibrating table having a multiplicity of holes therethrough, said particles being deposited proximate to the upper edge of said vibrating table;
b) an air source providing pressurized air through said multiplicity of holes in the vibrating table;
c) a trough positioned along the lower edge of said table, said trough configured to transport debris from the vibrating table; and,
d) a deforming mechanism positioned to selectively deform the lower edge of said table such that a portion of an upper surface of the table is positioned below said trough.

10. The refining mechanism according to claim 9, further including a control mechanism responsive to a first operator input in controlling the amount of deformation caused by said deforming mechanism.

11. The refining mechanism according to claim 10, wherein said control mechanism is responsive to a second operator input in controlling the amount of air pressure delivered by said air source to said vibrating table.

12. The refining mechanism according to claim 11, wherein said control mechanism is responsive to a third operator input in controlling an amount of vibration being performed by said vibrating table.

13. The refining mechanism according to claim 9, further including a catch basin for material from the deformed lower edge of said table not being collected by said trough.

14. The refining mechanism according to claim 13, wherein said deforming mechanism includes:
a) a reel having a cable thereon, a first end of said cable connected to said reel; a second end of said cable secured to said vibrating table at a bottom surface thereof and proximate to the lower edge of said vibrating table; and,
b) a motor selectively operating said reel.

15. The refining mechanism according to claim 14, further including a classification mechanism interposed between a source of particles and said table, said classification mechanism permitting only a defined diameter of particles to pass to the vibrating table.

16. A refining mechanism receiving particles, said refining mechanism comprising:
a) an air suspension vibrating table having an upper edge and an opposing lower edge, said air suspension vibrating table receiving particles proximate to the upper edge thereof;
b) a trough positioned along the lower edge of said table, said trough configured to transport debris from the vibrating table;
c) a deforming mechanism positioned to selectively deform the lower edge of said table such that a portion of an upper surface of the table is positioned below said trough; and,
d) a collection basin receiving particles passing from the lower edge under said trough.

17. The refining mechanism according to claim 16, further including a control mechanism being responsive to operator input for controlling:
a) an amount of deformation caused by said deforming mechanism;
b) an amount of air pressure delivered to the air suspension vibrating table;
c) an amount of vibration being performed by said air suspension vibrating table; and,
d) a tile of said air suspension vibrating table.

18. The refining mechanism according to claim 17, wherein said deforming mechanism includes:
c) a cam engaging the lower edge of said air suspension vibrating table; and,
d) a motor selectively operating said cam.

19. The refining mechanism according to claim 18, further including a classification mechanism interposed between said source of particles and said table, said classification mechanism permitting only a defined diameter of particles to pass to the vibrating table.
